(19) United States
(12) Patent Application Publication
(10) Pub. No.: US 2022/0347878 A1
(43) Pub. Date: Nov. 3, 2022

(54) BISCUIT SLICER

(71) Applicant: William Oliver Young, Spartanburg, SC (US)

(72) Inventor: William Oliver Young, Spartanburg, SC (US)

(21) Appl. No.: 17/244,436

(22) Filed: Apr. 29, 2021

(51) Int. Cl. B26B 29/06

(52) U.S. Cl. CPC B26B 29/063; B26B 2029/066

(57) ABSTRACT

A cutting system includes a chamber for receiving and positioning a biscuit or bread for consistent and uniform cutting. The system gently holds the biscuit in position as a blade cuts the biscuit along a knife guide in the system to produce optimal biscuit portions having strength and stability to hold food stuffs therebetween while being held and eaten by a consumer.

### BACKGROUND OF THE DISCLOSURE

Many restaurants—particularly fast-food restaurants—serve breakfast biscuits, hoagie or submarine sandwiches, and the like. And most fast-food restaurants bake their rolls and biscuits on site to ensure freshness. The fresh baked items having different thicknesses are cut by workers in rapid succession, and a variety of toppings are placed on or between the sliced bread or biscuits. For instance, a worker typically will use a knife to cut a breakfast biscuit to place bacon, eggs, cheese, or other ingredients on one part of the biscuit and then cover the ingredients with the other part of the biscuit. A drawback to using a knife to cut biscuits freehand is that even the best worker can be inconsistent and can unevenly slice biscuits, particularly during a customer rush hour. The conventional slicing approach often results in an uneven or thin biscuit part, which then crumbles in hand when a customer attempts to eat the biscuit. The problem is compounded by inconsistencies among different workers and still further, between restaurants. Moreover, freehand use of knives during a mealtime rush can result in injuries to hurried or inexperienced workers.

What is needed in the restaurant industry is a slicing system that will permit uniform, consistent, and safer cutting of rolls, biscuits, and the like without regard to skill level or experience of a worker.

### BRIEF SUMMARY OF THE DISCLOSURE

The present disclosure is directed in general to slicing or cutting systems that promote consistency and safety in cutting rolls, biscuits, and the like at an optimum point to maintain structural integrity of the food item when it is being eaten by a consumer. The cutting systems are simple to make, easy to use, and provide a uniform product to consumers.

In an exemplary embodiment, a slicing system may include a movable cover; a receiving tray disposed below the movable cover and configured to receive a food item such as bread, a roll, or a biscuit, the movable cover being positionable over the food item to secure the food item on the receiving tray for cutting the food item, wherein the movable cover automatically adjusts to a height of the food item; and a slit assembly disposed between the movable cover and the receiving tray, the slit assembly having a slit defined therethrough, the slit being configured for alignment with an optimum point of the food item based on its height, and being further configured to receive a blade for slicing the food item between the receiving tray and the movable cover.

The movable cover in this embodiment may further include one or more hinges or mechanical linkages for rotating the movable cover in a downward arc over the food item. A handle may be provided for moving the movable cover, and the movable cover may also include a gently-gripping, non-damaging surface for contacting the food item.

The slicing system may also include a bumper located between the receiving tray and the movable cover for positioning, centering, and rendering the food item stationary for cutting. The mechanical linkages keep the cover, the slit assembly, and the receiving tray parallel in any position or state of the slicing system. Still further, a plunger for ejecting the food item from the receiving tray may be provided, and the plunger may have a spring with a spring constant that urges the plunger away from the receiving tray.

The slicing system may further include a table that is attachable to the receiving tray. The table can be used to hold or stage food items in preparation for cutting, or for further disposition after being cut through the slit by the blade.

In another embodiment, a slicing system may include a movable cover having a gripping surface thereunder for gripping a food item; a receiving tray disposed below the movable cover and configured to receive the food item; a bumper disposed between the receiving tray and the movable cover, the movable cover positionable over the food item and the bumper and the gripping surface being configured to render the food item stationary for cutting; a slit assembly disposed between the movable cover and the receiving tray, the slit assembly having a slit defined therethrough, the slit being slaved to the movable cover configured to align with an optimal point or position of the food item; and a blade for slicing the food item, e.g., horizontally at the optimal point, through the slit.

The movable cover in this embodiment may have a hinge configured to rotate the movable cover in a downward arc over the food item and to position the slit at the optimal cutting point of the food item, and the blade may be an automatic knife mechanism that automatically engages and cuts the food item when the movable cover is positioned over the food item. A plunger may be provided for ejecting the food item from the receiving tray after the food item is sliced.

In yet another embodiment, a slicing system may include a movable cover having a gripping surface thereunder for gripping a food item; a receiving tray disposed below the movable cover with an elevating surface configured to receive the food item; a bumper disposed between the receiving tray and the movable cover, the movable cover positionable over the food item and the bumper and the gripping surface being configured to render the food item stationary for cutting; a slit assembly disposed between the movable cover and the receiving tray, the slit assembly having a slit defined therethrough, the elevating surface being vertically adjustable to align an optimal point or position of the food item with the slit; and a knife mechanism disposed proximate the slit assembly, the knife mechanism having a blade that automatically engages and slices the food item at the optimal point through the slit when the movable cover is positioned over the food item.

The movable cover in this embodiment may include a hinge configured to rotate the movable cover in a downward arc over the food item, and further include a plunger for ejecting the food item from the receiving tray.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 shows a top, partial perspective view of an embodiment of a cutting system in an open position according to an aspect of the disclosure;

FIG. 2 is an end view of the embodiment of FIG. 1, taken partially along lines 2-2 FIG. 1;

FIG. 3 is a top, partial perspective view of the embodiment as in FIG. 1, particularly showing a closed position;

FIG. 4 is a top, partial plan view of the embodiment as in FIG. 1 showing some elements in phantom for clarity;

FIG. 5 is a side view of the embodiment taken along lines 5-5 in FIG. 4;

FIG. 6 is a side view of the embodiment as in FIG. 4, particularly showing the embodiment in a closed state;

FIG. 7 is a side view of the embodiment as in FIG. 4, particularly showing a plunger being compressed to eject a food item; and

FIG. 8 is a partial, top plan view of another embodiment of a cutting system according to another aspect of the disclosure showing some elements in phantom for clarity.

### DETAILED DESCRIPTION OF THE DISCLOSURE

As required, detailed embodiments are disclosed herein; however, the disclosed embodiments are merely exemplary and may be embodied in various forms. Therefore, specific structural and functional details disclosed herein are not to be interpreted as limiting, but merely as a basis for the claims and as a representative basis for teaching one skilled in the art to variously employ the exemplary embodiments of the present disclosure, as well as their equivalents.

Unless defined otherwise, all technical and scientific terms used herein have the same meaning as is commonly understood by one of ordinary skill in the art to which this disclosure belongs. In the event that there is a plurality of definitions for a term or acronym herein, those in this section prevail unless stated otherwise.

Wherever the phrase “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly, “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etcetera. Thus, for example, “a device having components a, b, and c” means that the device includes at least components a, b, and c. Similarly, the phrase “a method having a, b, and c” means that the method includes at least steps a, b, and c.

Where a list of alternative component terms is used, e.g., “a structure such as ‘a’, ‘c’, ‘d’ or the like,” or “a or b,” such lists and alternative terms provide meaning and context for the sake of illustration, unless indicated otherwise. Alternative terms also may be presented in this order “‘a’, ‘b’, or ‘c’” followed by an element number. Also, relative terms such as “first,” “second,” “third,” “front,” and “rear” are intended to identify or distinguish one component or feature from another similar component or feature, unless indicated otherwise herein.

Unless the context clearly requires otherwise, throughout the description and the claims, the words “comprise,” “comprising,” and the like are to be construed in an inclusive sense as opposed to an exclusive or exhaustive sense; in the sense of “including, but not limited to.”

The various embodiments of the disclosure and/or equivalents falling within the scope of present disclosure overcome or ameliorate at least one of the disadvantages of the prior art or provide a useful alternative.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

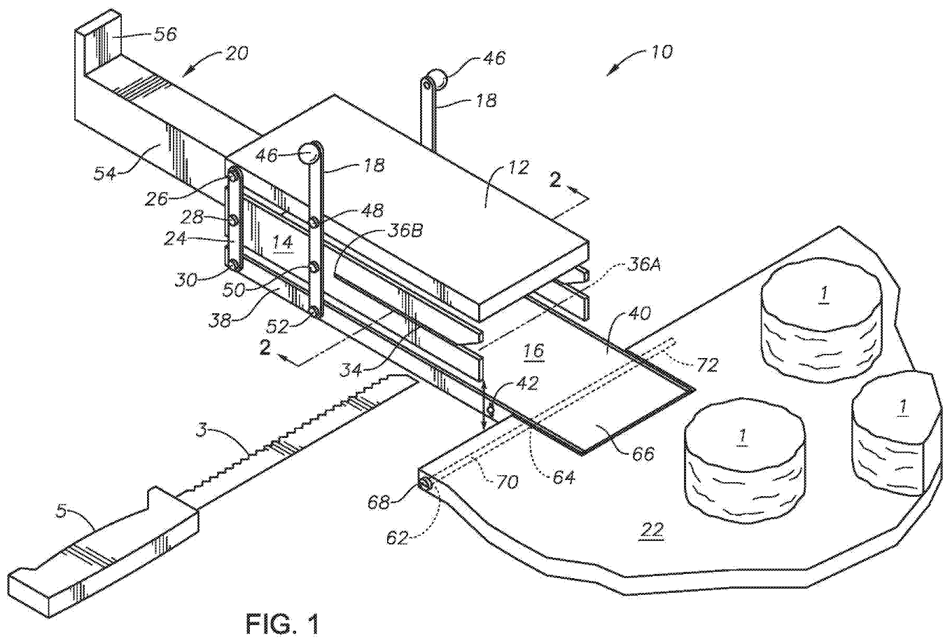

Turning now to FIG. 1, a bread, roll, or biscuit slicing system according to the disclosure is designated broadly by element number 10. Here, the exemplary slicing system 10 is shown in a first or open state or position and may include a movable top or cover 12 operably positioned above a slicing chamber or body 14 and a receiving tray 16. The movable cover 12 and the slicing body 14 are rotationally secured to the receiving tray 16 with pivoting handles 18 and hinges 24, which are described in greater detail below.

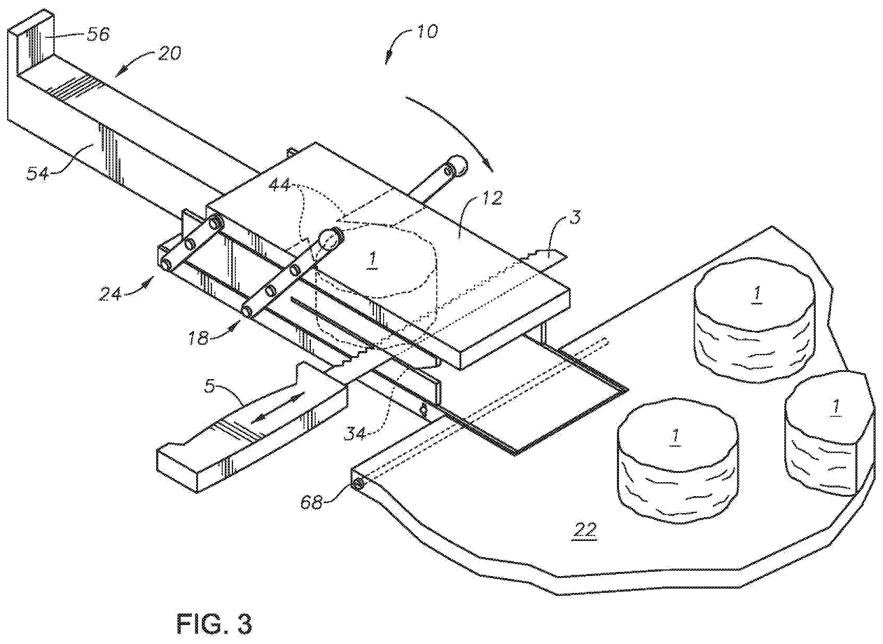

FIG. 1 further shows a push-plunger or push rod 20 operably attached between the movable cover 12 and the slicing body 14 with the receiving tray 16 releasably secured to a biscuit holding area, tray, or table 22. In this example, at least one hinge 24, as briefly introduced above, may further include a top pivot or pivot point 26, a middle pivot or pivot point 28, and a bottom pivot or pivot point 30, which are respectively connected to the movable cover 12, the slicing body 14, and the receiving tray 16. Briefly, and as explained in further detail by example operation below, when the exemplary slicing system 10 is moved from the open position shown in FIG. 1 to a closed position or state as shown in FIG. 3, the pivots 26, 28, and 30 permit the cover 12 to move in a downward arc toward the table 22 to gently hold a food item, such as a biscuit 1, in place for cutting the biscuit 1 with a knife 3 having a handle 5. The knife 3 may be a stainless-steel blade with a smooth coating such as Teflon® material, may be serrated, and may be relatively thin, e.g., approximately 0.040 inches in thickness to easily slice relatively fragile biscuits 1. Also, due to their intended use with consumable food items, the movable cover 12, the slicing body 14, the receiving tray 16, and the table 22 may be made from metal such as stainless steel or reinforced aluminum to make the components easy to clean and sanitize for food preparation and handling.

With continued reference to FIG. 1, the slicing body 14 may include a blade guide or slit 34 with an entryway 36A and a terminal end 36B (with a complementary slit 34, entryway 36A, and terminal end 36B on an opposite side of the slicing body 14). In this example, the slicing body 14 is linked or slaved to the movable cover 12 via the pivots 26 and 28 and adjusts to an optimal or optimum cutting point of a biscuit 1 according to biscuit height; i.e., the height of the biscuit 1 dictates a stopping position of the movable cover 12 and the slicing body 14, and thus, the slit 34, relative to the biscuit 1. Preferably, the stopping point is about 3/16 inch below center of the biscuit 1 but is not limited thereto. Also shown in this example, the entryway 36A is a relatively wide opening, angular in shape, to receive the knife 3 more easily into the slit 34. The blade slit 34 from its entryway 36A to its terminal end 36B may be made of or coated with UHMW (ultra-high-molecular-weight) polyethylene to permit the knife 3 to slide along the slit 34 with minimal friction.

The receiving tray 16 in FIG. 1 may include a base 38 with an elevating section, elevator, or elevating platform 40 and a distal end 66 extending into the table 22 as described in more detail below. As shown, the elevating section 40 may further include an adjustment knob, lever, toggle, or screw 42 to raise or lower the elevating section 40—as indicated by the vertically oriented double-headed arrow—relative to the slit 34 and the base 38 to assist with centering and aligning biscuits 1 within a chamber of the slicing body 14.

Most biscuits 1 will be about 1.5 inches to about 1.75 inches in height after baking. The bottoms of the biscuits 1 will be flat and relatively strong since a pan or tray will bake those areas flat while the tops of the biscuits 1 will be airier and will often be uneven or irregular. The inventor has discovered that an optimum or optimal point or position to cut a biscuit 1 of about 1.5 inches in height is approximately 3/16 of an inch below a horizontal center of the biscuit 1. See, e.g., cut line 7 in FIG. 6. Thus, this optimum cutting point slightly below center results in relatively strong bottom and upper portion of the biscuit 1; i.e., the bottom portion, which is flatter and stronger at bottom, will be relatively shorter than the airier upper portion, which therefore requires more biscuit material to hold the two portions together when eaten. Still further, if a particular batch of biscuits 1 are baked relatively taller or flatter, to achieve the optimal cut, the elevating section 40 may need to be lowered, or raised, such that the slit 34 is aligned along relative optimum cutting points of the batch of biscuits 1 before cutting them. However, if the elevating section 40 is not provided, the movable cover 12 and the slicing body 14 can automatically adjust to a biscuit height such that the slit 34 will be aligned along the relative optimum cutting point of the biscuit 1 and be cut about 3/16 inch below its horizontal center.

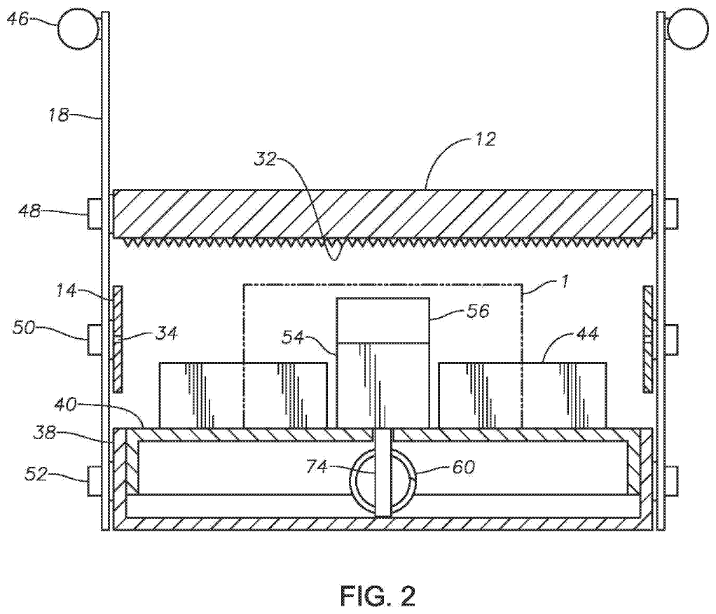

The handles 18 in FIG. 1 may include respective knobs 46, a cover pivot point 48, a middle pivot point 50, and a bottom pivot point 52, which are respectively connected to the movable cover 12, the slicing body 14, and the receiving tray 16. Like the pivot 24 above, when the slicing system 10 is moved to a closed state as in FIG. 2, the handles 18 can be rotated forward on the pivot points 48, 50, and 52 in a downward arc to gently press the cover 12 over one of the biscuits 1 for cutting. Once cut, a proximal end or grip 56 (see FIG. 3) of the plunger 20 is used to push the biscuit 1 out of the slicing body 14 in a direction of the tray 22.

Also shown in FIG. 1, the table 22 can be shaped to receive the distal end 66 of the receiving tray 16. Here, the distal end 66 and the table 22 can be releasably connected using a screw or rod 68 that can be detached when the components are to be cleaned. More specifically, the tray 22 may include a table aperture 62 through which a body 70 of the screw 68 extends, which further extends into a receiving aperture 64 of the receiving tray 16 to connect the tray 16 and the table 22. When the time comes to clean or maintain the system 10, the screw 68 can be removed to release the tray 16 from the table 22.

FIG. 2 is an end view of the slicing system 10 showing a biscuit 1 (in phantom for clarity) positioned for cutting. Here, the respective handles 18 with knobs 46 are ready to rotate forward to close the slicing system 10 to gently press a non-damaging, gripping surface or gripper 32 against the biscuit 1 seated on the elevating section 40. In this example, the gripper 32 may be made from an aluminum sheet or section with a plurality of perforations therethrough, but the surface 32 may be a sandpaper-like material, a series of miniature spikes, et cetera. The gripper 32 may be attached to a bottom area of the cover 12 using glue, rivets, or the like, or it may be slidably removable from the cover 12 for cleaning, for instance. Also shown in this example, the biscuit 1 is positioned in the slicing system 10 by berms, stops, or bumpers 44 for cutting the biscuit 1 at a level of the slits 34. After the biscuit 1 is sliced, the proximal end 56 of the body 54 of the plunger 20 is used to push the biscuit 1 out of the system 10.

FIG. 3 shows the slicing system 10 in the closed state with the biscuit 1 (shown in phantom for clarity) positioned for cutting. As introduced with respect to FIG. 1, respective handles 18 and pivots 24 have been rotated forward to close the slicing system 10, which gently presses the cover 12 over the biscuit 1 for cutting with the knife 3. More specifically, the biscuit 1 is centered in the slicing system 10 between slits 34. As shown in phantom for clarity, the bumpers 44 position the biscuit 1 for cutting. After the biscuit 1 is cut by the knife 3 via a sawing action of the handle 5, as indicated by the doubled-headed arrow, the proximal end 56 of the body 54 of the plunger 20 is used to push the biscuit 1 out of the system 10 in a direction of the table 22.

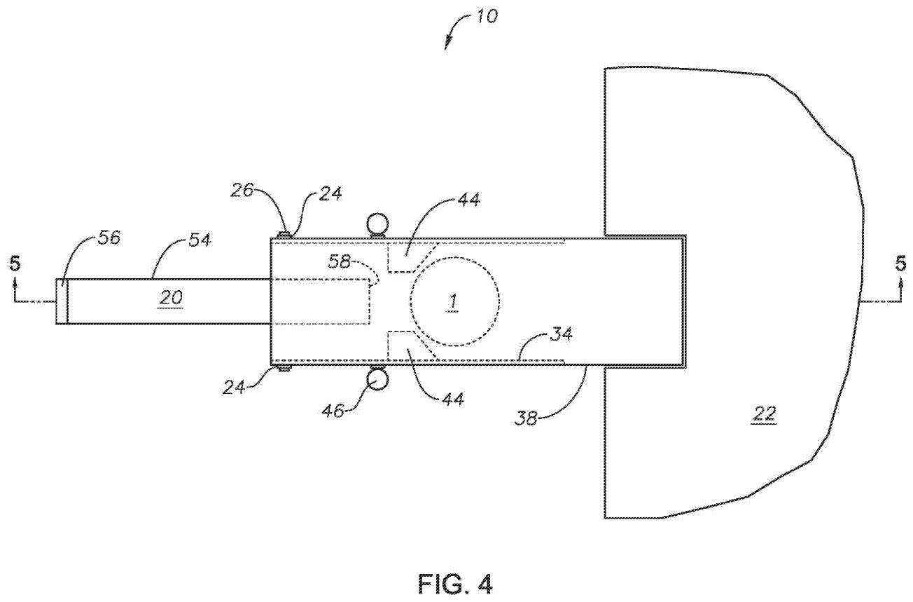

FIG. 4 shows the components of the system 10 from a top view and partially in phantom for additional clarity and detail, although the components may not be shown to scale nor in precise order of assembly. Here, the biscuit 1 is placed on the cutter base 38 and abuts the bumpers 44 within a chamber of the system 10. When the knife 3 as in FIG. 1 slices along the slit 34, the biscuit 1 is sliced in half horizontally. And when the system 10 is opened by rotating the handles 46 and the pivots 24 away from the table 22, the push end 58 is then used to slide the sliced biscuit 1 toward or onto the table 22.

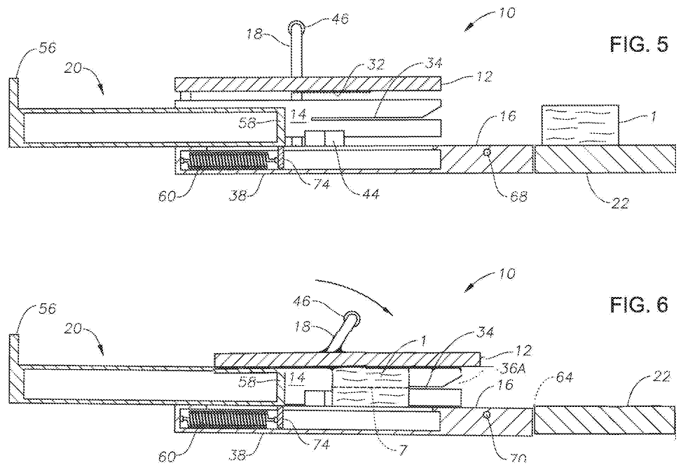

FIGS. 5 and 6 show the embodiment in FIG. 3 in partial cross section. As introduced above, the biscuit 1 is placed between the slits 34, and the cover 12 is pushed down onto the biscuit 1. The gripper 32, which can be a sandpaper like surface or small perforations n metal as noted above, will gently hold the biscuit 1 in place while a blade is inserted into the opening 36A to cut the biscuit 1 at its optimum cutting point, as indicated by cut line 7 in the biscuit 1. In this example, a spring 60 within the plunger 20 is shown between the grip 56 and the push end 58.

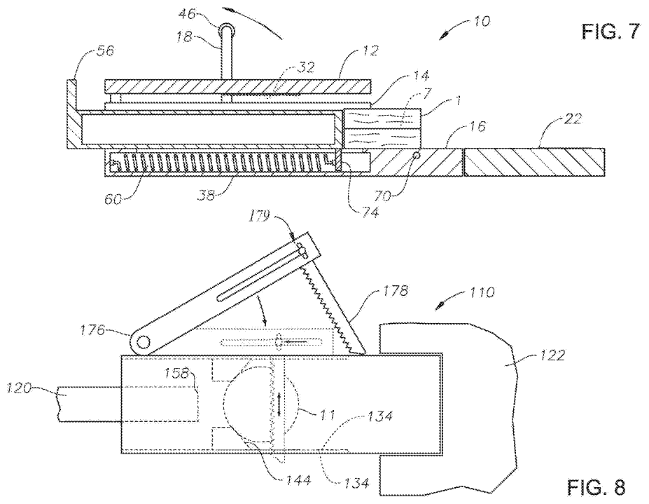

With continued reference to FIGS. 5 and 6 generally and to FIG. 7 specifically, the spring 60 is stopped by a block or barrier 74 near the push end 58 such that, when the plunger 20 is pushed toward the slits 34 of the assembly 14, the barrier 74 blocks the spring 60 from moving in a direction of the table 22 while a spring constant of the spring 60 urges the spring 60 to return to the position shown in FIG. 5. Thus, when a worker releases the grip 56 after pushing out the biscuit 1, the compressed spring 60 as in FIG. 7 will return the plunger 20 to its resting state as in FIG. 5.

With reference now to FIG. 8, another embodiment of a biscuit slicing system according to the disclosure is designated broadly by element number 110. The exemplary system 110 may include a plunger 120, a table 122, a set of slicing guides 134, and a knife mechanism 176. When a biscuit 11 is positioned within the system 110 against a set of bumpers 144, and the system 110 is moved to closed state, the knife mechanism 176 and its knife 178 rotates, swings, or extends in a direction of the biscuit 11 and begins automatically slicing the biscuit 11. In this example, the knife 178 may be attached to the knife mechanism 176 by a reciprocating assembly 179 that moves the blade 178 in a direction of the plunger 120 and simultaneously moves the blade 178 back and forth to cut biscuit 11, as indicated by the double-headed arrow. Once the cutting is completed, the blade 178 automatically retracts and the push end 158 of the plunger 120 can be used to push the sliced biscuit 11 toward or onto the table 122. Although a rotating blade 178 is shown in this example, the knife mechanism 176 could include a straight blade that projects in a direction of the biscuit 1 when the system 110 is moved to closed state, or a two relatively shorter blades can be positioned on either side of the system 110 to cut the biscuit 1 from both sides.

### Embodiment 1

A slicing system, comprising a movable cover; a receiving tray disposed below the movable cover and configured to receive a food item, the movable cover being positionable over the food item to secure the food item on the receiving tray for cutting the food item; a slit assembly disposed between the movable cover and the receiving tray, the slit assembly having a slit defined therethrough, the slit being configured for alignment with the food item and being further configured to receive a blade for slicing the food item between the receiving tray and the movable cover.

### Embodiment 2

The slicing system as in Embodiment 1, wherein the movable cover includes a hinge being configured to rotate the movable cover in a downward arc over the food item.

### Embodiment 3

The slicing system as in Embodiments 1 or 2, wherein the movable cover includes a gripping surface for contacting the food item.

### Embodiment 4

The slicing system as in any of the foregoing embodiments, wherein the food item is one of bread, a roll, and a biscuit.

### Embodiment 5

The slicing system as in any of the foregoing embodiments, further comprising a bumper disposed between the receiving tray and the movable cover to render the food item stationary for cutting.

### Embodiment 6

The slicing system as in any of the foregoing embodiments, further comprising a handle for moving the movable cover.

### Embodiment 7

The slicing system as in any of the foregoing embodiments, further comprising a plunger for ejecting the food item from the receiving tray.

### Embodiment 8

The slicing system as in Embodiment 7, wherein the plunger includes a spring having a spring constant urging the plunger away from the receiving tray.

### Embodiment 9

The slicing system as in any of the foregoing embodiments, further comprising a table attachable to the receiving tray, the table being configured to stage the food item.

### Embodiment 10

The slicing system as in any of the foregoing embodiments, further comprising the blade for slicing the food item along the slit.

### Embodiment 11

A slicing system, comprising a movable cover having a gripping surface thereunder for gripping a food item; a receiving tray disposed below the movable cover and configured to receive the food item; a bumper disposed between the receiving tray and the movable cover, the movable cover positionable over the food item and the bumper and the gripping surface being configured to render the food item stationary for cutting; a slit assembly disposed between the movable cover and the receiving tray, the slit assembly having a slit defined therethrough, the slit being slaved to the movable cover and configured to align with an optimal cutting point of the food item when the movable cover is positioned over the food item; and a blade for slicing the food item through the slit.

### Embodiment 12

The slicing system as in Embodiment 11, wherein the movable cover includes a hinge being configured to rotate the movable cover in a downward arc over the food item.

### Embodiment 13

The slicing system as in Embodiments 11 or 12, wherein the blade is an automatic knife mechanism that automatically engages and cuts the food item when the movable cover is positioned over the food item.

### Embodiment 14

The slicing system as in Embodiments 11, 12 or 13, further comprising a plunger for ejecting the food item from the receiving tray.

### Embodiment 15

A slicing system, comprising a movable cover having a gripping surface thereunder for gripping a food item; a receiving tray disposed below the movable cover with an elevating surface configured to receive the food item; a bumper disposed between the receiving tray and the movable cover, the movable cover positionable over the food item and the bumper and the gripping surface being configured to render the food item stationary for cutting; a slit assembly disposed between the movable cover and the receiving tray, the slit assembly having a slit defined therethrough, the elevating surface being vertically adjustable to align an optimum point of the food item with the slit; and a knife mechanism disposed proximate the slit assembly, the knife mechanism having a blade that automatically engages and slices the food item through the slit when the movable cover is positioned over the food item.

### Embodiment 16

The slicing system as in Embodiment 15, wherein the movable cover includes a hinge being configured to rotate the movable cover in a downward arc over the food item.

### Embodiment 17

The slicing system as in Embodiments 15 or 16, further comprising a plunger for ejecting the food item from the receiving tray.

In any of the foregoing embodiments, various metals, plastics, and the like may be used that are appropriate for food handling equipment.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. A slicing system, comprising:
a movable cover being configured to rotate in a downward arc over a food item;
a receiving tray disposed below the movable cover and configured to receive the food item, the movable cover being positionable over the food item to secure the food item on the receiving tray for cutting the food item; and
a slit assembly disposed between the movable cover and the receiving tray, the slit assembly having a slit defined therethrough, the slit being configured for alignment with an optimal cutting point of the food item by the movable cover and being further configured to receive a blade for slicing the food item between the receiving tray and the movable cover.

2. The slicing system as in claim 1, wherein the movable cover includes a hinge being configured to rotate the movable cover in the downward arc over the food item.

3. The slicing system as in claim 1, wherein the movable cover includes a gripping surface for contacting the food item.

4. The slicing system as in claim 1, wherein the food item is one of bread, a roll, and a biscuit.

5. The slicing system as in claim 1, further comprising a bumper disposed between the receiving tray and the movable cover to render the food item stationary for cutting.

6. The slicing system as in claim 1, further comprising a handle for moving the movable cover.

7. The slicing system as in claim 1, further comprising a plunger for ejecting the food item from the receiving tray.

8. The slicing system as in claim 7, wherein the plunger includes a spring having a spring constant urging the plunger away from the receiving tray.

9. The slicing system as in claim 1, further comprising a table attachable to the receiving tray, the table being configured to stage the food item.

10. The slicing system as in claim 1, further comprising the blade for slicing the food item along the slit.

11. A slicing system, comprising:
a movable cover having a gripping surface thereunder for gripping a food item;
a receiving tray disposed below the movable cover and configured to receive the food item;
a bumper disposed between the receiving tray and the movable cover, the movable cover positionable over the food item and the bumper and the gripping surface being configured to render the food item stationary for cutting;
a slit assembly disposed between the movable cover and the receiving tray, the slit assembly having a slit defined therethrough, the slit being slaved to the movable cover and configured to align with an optimal cutting point of the food item when the movable cover is positioned over the food item; and
a blade for slicing the food item through the slit.

12. The slicing system as in claim 11, wherein the movable cover includes a hinge being configured to rotate the movable cover in a downward arc over the food item and to position the slit at the optimal cutting point of the food item.

13. The slicing system as in claim 11, wherein the blade is an automatic knife mechanism that automatically engages and cuts the food item when the movable cover is positioned over the food item.

14. The slicing system as in claim 11, further comprising a plunger for ejecting the food item from the receiving tray.

15. A slicing system, comprising:
a movable cover having a gripping surface disposed thereunder for gripping a food item;
a receiving tray disposed below the movable cover with an elevating surface configured to receive the food item;
a bumper disposed between the receiving tray and the movable cover, the movable cover positionable over the food item and the bumper and the gripping surface being configured to render the food item stationary for cutting;
a slit assembly disposed between the movable cover and the receiving tray, the slit assembly having a slit defined therethrough, the elevating surface being vertically adjustable to align the slit with an optimal cutting point of the food item; and
a knife mechanism disposed proximate the slit assembly, the knife mechanism having a blade that automatically engages and slices the food item through the slit when the movable cover is positioned over the food item.

16. The slicing system as in claim 15, wherein the movable cover includes a hinge being configured to rotate the movable cover in a downward arc over the food item and to position the slit at the optimal cutting point of the food item.

17. The slicing system as in claim 15, further comprising a plunger for ejecting the food item from the receiving tray.
